(19) United States
(12) Patent Application Publication
(10) Pub. No.: US 2022/0030492 A1
(43) Pub. Date: Jan. 27, 2022

(54) SYSTEM AND METHOD FOR OPERATING CONNECTED DEVICE WITH USER TERMINAL HAVING HETEROGENEOUS COMMUNICATION MODULES

(71) Applicant: HYUNDAI MOBIS CO., LTD., Seoul (KR)

(72) Inventor: Woo Jong LEE, Yongin-si (KR)

(73) Assignee: HYUNDAI MOBIS CO., LTD., Seoul (KR)

(21) Appl. No.: 17/380,416

(22) Filed: Jul. 20, 2021

(30) Foreign Application Priority Data
Jul. 22, 2020 (KR) 10-2020-0091143

(51) Int. Cl. H04W 36/28; H04W 4/48

(52) U.S. Cl. CPC H04W 36/28; G06F 3/0482; H04W 4/48

(57) ABSTRACT

Provided is a system for operating a connected device with a user terminal having heterogeneous communication modules, the system including a screen input/output device comprising a touch screen, a first communication device configured to perform wireless communication with a user terminal, a second communication device, which uses a different type of wireless communication method from that of the first communication device, a user authentication device configured to receive authentication information for authenticating a user, and a controller configured to, at a time of connection of the user terminal, authenticate a driver through the authentication information input through the user authentication device, load a profile of the authenticated driver to check the user terminal having a high priority, and connect to the user terminal through the first communication device or the second communication device.

### CROSS-REFERENCE TO RELATED APPLICATIONS

This application claims priority to and the benefit of Korean Patent Applications No. 10-2020-0091143, filed on Jul. 22, 2020, the disclosure of which is incorporated herein by reference in its entirety.

### BACKGROUND OF THE INVENTION

### 1. Field of the Invention

The present invention relates to a system for operating a connected device with a user terminal having heterogeneous communication modules, and more specifically, to a method of operating a wireless connection between a vehicle device and a user terminal.

### 2. Discussion of Related Art

In conventional methods of operating an in-vehicle connected device, Bluetooth of an audio-video-navigation (AVN) system in a vehicle is activated and then an external user terminal is registered.

After the user terminal is registered, an activation of Bluetooth of the AVN system in the vehicle allows a device registered in Bluetooth to be searched for, and when there is the registered device, the device is allowed to be connected.

The present invention relates to a method of efficiently setting an external device that is to execute an interworking function in the conventional multimedia system of a vehicle, and a vehicle capable of performing the same.

The conventional multimedia system of a vehicle connected to an external device may perform operations of being connected to one or more external devices; determining the number of the connected external devices; when the determined number of external devices is one, setting the one external device as a default device to perform the interworking function; when the determined number of external devices is two or more, displaying a pop-up window on a display for receiving a selection of one of the plurality of external devices; and setting the external device selected through the pop-up window as the default device.

However, the conventional multimedia system of a vehicle connected to an external device has a limitation due to connecting a default device having a high priority among devices connected to an AVN system.

### BRIEF SUMMARY OF THE INVENTION

The present invention is directed to providing a system for operating a connected device with a user terminal having heterogeneous communication modules.

The technical objectives of the present invention are not limited to the above, and other objectives may become apparent to those of ordinary skill in the art based on the following description.

According to an aspect of the present invention, there is provided a system for operating a connected device with a user terminal having heterogeneous communication modules, the system including: a screen input/output device comprising a touch screen; a first communication device configured to communicate with a user terminal via a first wireless network of a first wireless communication type; a second communication device, configured to communicate with the user terminal via a second wireless network of a second wireless communication type different from the first wireless communication type; a user authentication device configured to receive authentication information of a user; and a controller configured to, at a time of connection with the user terminal, authenticate a driver based on the received authentication information, load a profile of the authenticated driver to check whether the user terminal has a high priority or not, and connect to the user terminal using the first or second communication device.

The user authentication device may be configured to use at least one of: a biometric information recognizer configured to acquire biometric information of the user; a camera configured to capture facial information of the user; an identifier information inputter configured to output, through the screen input/output device, a graphic user interface (GUI) for receiving identifier information from the user; and a profile selector configured to output a list of registered profiles .

The controller may be configured to identify the user using at least one of the biometric information of the user acquired through the biometric information recognizer, the facial information of the user acquired through the camera, the identifier information input through the identifier information inputter, and the profile information selected by the user.

The controller may be configured to: search for the user terminal accessible through the first communication device and the second communication device; display, on the touch screen of the screen input/output device, information about the user terminal; receive a user input selecting the user terminal from the information displayed on the touch screen; and in response to receiving the user input, store, in a data storage, information about the selected user terminal as a profile of the user.

The controller may be configured to: recognize, using the user authentication device, the driver; upon the driver being recognized, retrieve profile information of the driver and output, via the screen input/output device, the retrieved profile information; and attempt to access, using the first or second communication device, the user terminal according to a connection priority of the user terminal .

The controller may be configured to, when profile information of the driver is output and then the user selects a priority adjustment menu setting, display a control bar configured to allow the user to adjust a connection priority of the user terminal at one side of an output list of the user terminals, and to adjust the connection priority of the user terminal selected according to the driver selecting the control bar and then scrolling the control bar upward or downward.

The controller may be configured to: display a communication unit configured to perform communication with the user terminal as an icon; and adjust a position of the icon to change a priority setting for the communication unit that the user wishes to access.

The controller may be configured to, in response to a failure to recognize the driver based on a function of a biometric information recognizer, check a list of previously accessed user terminals, and attempt to access the user terminal according to the list of the previously accessed user terminals.

The controller is configured to apply a priority for the first or second communication device depending on a type of a program to be run.

According to another aspect of the present invention, there is provided a method of operating a connected device with a user terminal having heterogeneous communication modules, the method including: detecting a user terminal and then registering user profile information including user authentication information; after registering the user profile information, receiving the user authentication information to perform authentication on a user; in response to the user being authenticated, loading the user profile information corresponding to the authenticated user; and performing, based on the user profile information, connection with the user terminal having a high connection priority.

The method may further include, in response to the user not being authenticated, performing, based on a list of the user terminals previously accessed, connection with a user terminal having the high connection priority.

The method may further include, when a request signal for changing a connection priority of the user terminal is input after the loading of the profile information, outputting a control bar configured to allow the user to change a connection priority at one side of a list of the user terminals; and adjusting the connection priority according to a position of the control bar changed by the user.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a functional block diagram illustrating a system for operating a connected device with a user terminal having heterogeneous communication modules according to an embodiment of the present invention;

FIG. 2 is a functional block diagram for describing a user authentication device of FIG. 1;

FIG. 3 is a reference diagram illustrating an output state of connection priority list information for user terminals according to an embodiment of the present invention;

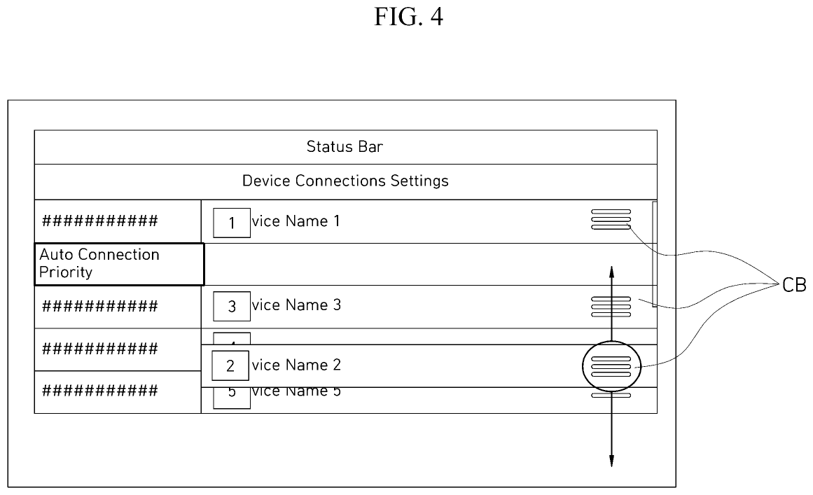

FIG. 4 is a reference diagram for describing a priority setting change according to an embodiment of the present invention;

FIGS. 5A and 5B are reference views illustrating a state in which a connection priority setting of user terminals and a communication module ranking are desired to be changed according to an embodiment of the present invention;

FIG. 6 is a reference diagram for describing details of a user profile according to an embodiment of the present invention;

FIG. 7 is a flowchart for describing a process of registering a user terminal in a system for operating a connected device with a user terminal having heterogeneous communication modules according to an embodiment of the present invention;

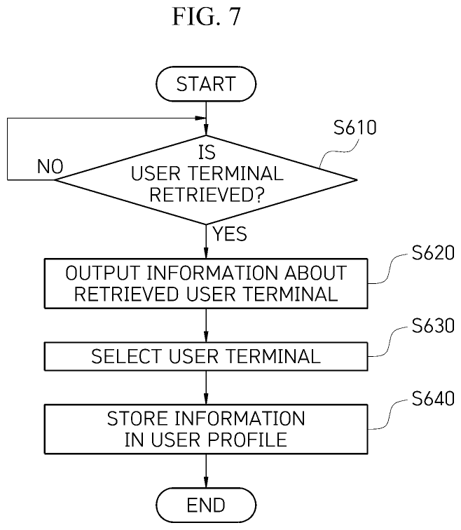

FIG. 8 is a flowchart for describing a connection process of a user terminal according to an embodiment of the present invention; and

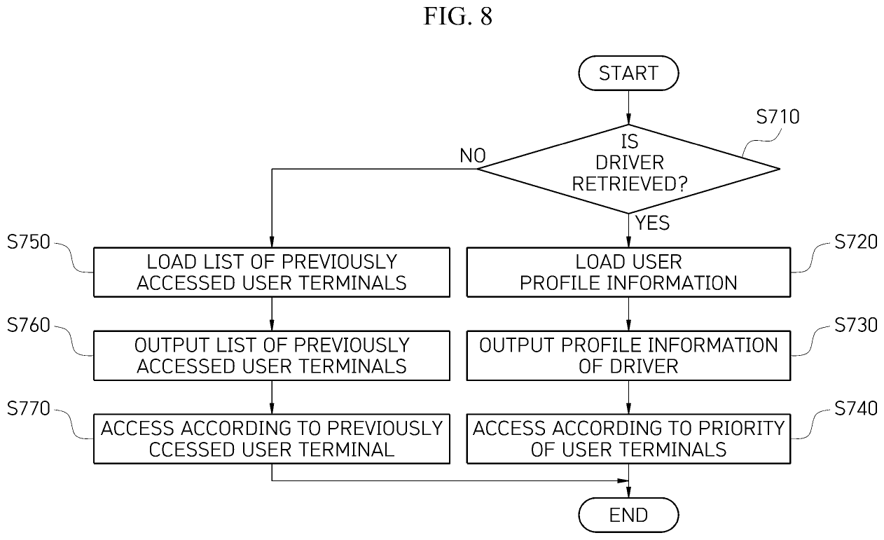

FIG. 9 is a flowchart for describing a method of setting a connection priority of user terminals according to an embodiment of the present invention.

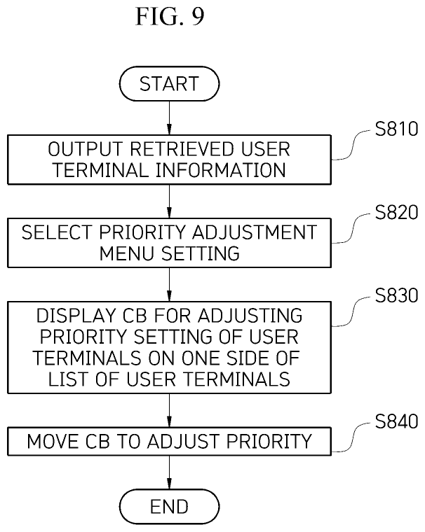

### DETAILED DESCRIPTION OF THE INVENTION

Hereinafter, the advantages and features of the present invention and ways of achieving them will become readily apparent with reference to descriptions of the following detailed embodiments in conjunction with the accompanying drawings. However, the present invention is not limited to such embodiments and may be embodied in various forms. The embodiments to be described below are provided only to complete the disclosure of the present invention and assist those of ordinary skill in the art in fully understanding the scope of the present invention, and the scope of the present invention is defined only by the appended claims. Terms used herein are used to aid in the description and understanding of the embodiments and are not intended to limit the scope and spirit of the present invention. It should be understood that the singular forms “a” and “an” also include the plural forms unless the context clearly dictates otherwise. The terms “comprises,” “comprising,” “includes,” and/or “including,” when used herein, specify the presence of stated features, integers, steps, operations, elements, components and/or groups thereof and do not preclude the presence or addition of one or more other features, integers, steps, operations, elements, components, and/or groups thereof.

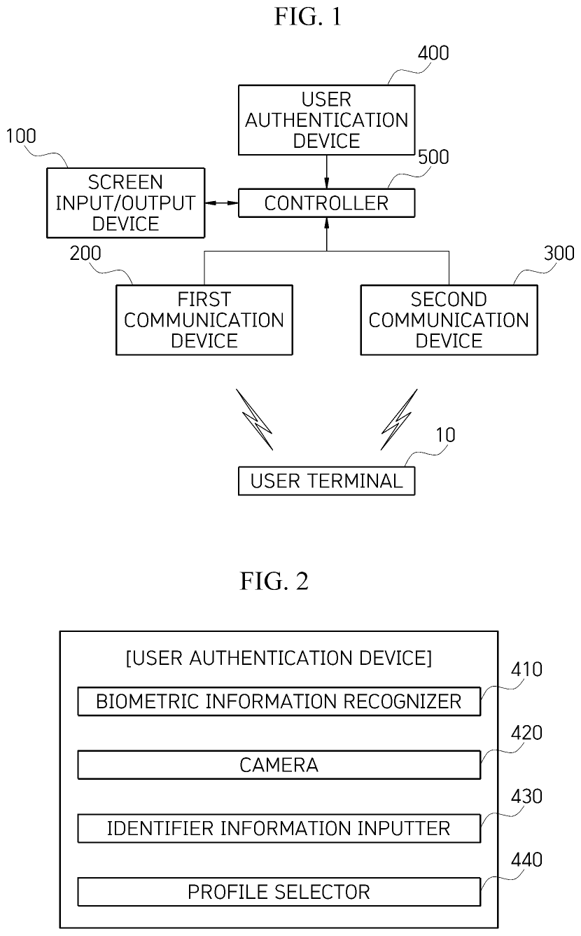

FIG. 1 is a functional block diagram illustrating a system for operating a connected device with a user terminal having heterogeneous communication modules according to an embodiment of the present invention. Referring to FIG. 1, a system for operating a connected device with a user terminal having heterogeneous communication modules according to an embodiment of the present invention includes a screen input/output device 100, a first communication device 200, a second communication device 300, a user authentication device 400, and a controller 500.

The screen input/output device 100 has a touch screen, and outputs information according to control of the controller 500 or receives information selected by a user.

The first communication device 200 is configured to communicate with a user terminal 10 via a wireless network of a first wireless communication type, (e.g., Bluetooth, etc.).

The second communication device 300 is configured to communicate with the user terminal 10 via another wireless network of a second wireless communication type (e.g., WiFi, etc.), which is different from the first wireless communication type of the first communication device 200.

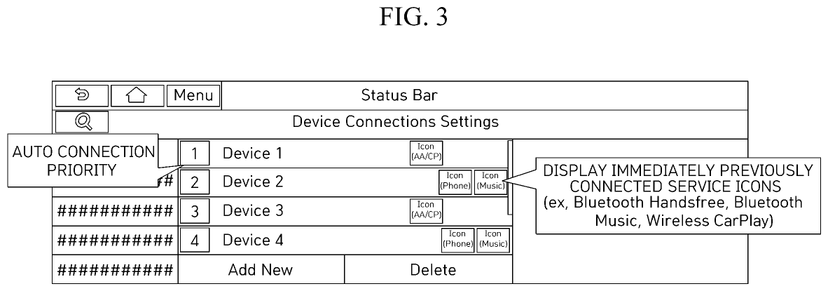

The user authentication device 400 is provided to acquire information for authenticating a user and may be provided using various types of authentication devices. Referring to FIG. 2, the user authentication device 400 according to the embodiment of the present invention includes a biometric information recognizer 410, a camera 420, an identifier information inputter 430, and a profile selector 440.

The biometric information recognizer 410 is provided to acquire biometric information of a user and may be provided using an iris recognizer or a fingerprint reader. The biometric information recognizer 410 is preferably installed inside the vehicle.

The camera 420 acquires image information including facial information of a user for acquiring the facial information of the user among pieces of user authentication information. The camera 420 may be installed inside the vehicle to recognize the face of not only the driver of the vehicle but also the faces of the passengers in the vehicle.

The identifier information inputter 430 outputs a graphic user interface (GUI) for receiving identifier information from a user through the screen input/output device 100. The identifier information according to the embodiment is preferably password information.

The profile selector 440 is provided to output a registered profile information list to the screen input/output device 100 and receive selection information from a user so that the user selects profile information, and the profile selector 440 does not include security information of an authenticator.

The controller 500 is configured to, at a time of connection with a user terminal, authenticate a driver through the biometric information recognizer 410, check a user terminal 10 having a high priority and a communication method from a profile of the authenticated driver, and connect to the user terminal through a corresponding one of the first communication device 200 and the second communication device 300.

Accordingly, the controller 500 may identify a user using at least one of biometric information of the user obtained through the biometric information recognizer 410, the facial information of the user obtained through the camera 420, the identifier information input through the identifier information inputter 430, and the profile information selected by the user, and may strengthen security through use of the pieces of information for user authentication.

According to the embodiment of the present invention, among user terminals authenticated through the user authentication device, a connection with a user terminal having a high priority is facilitated.

In addition, according to the present invention, a user may be authenticated through various types of user authentication devices or the security may be improved through multiple authentication.

In the embodiment of the present invention, at a time of setting registration of a user terminal, the controller 500 searches for a user terminal 10 accessible through the first communication device 200 and the second communication device 300 (S610) and outputs information about the retrieved user terminal 10 through the screen input/output device 100 so that the user may select the retrieved user terminal 10 (S620).

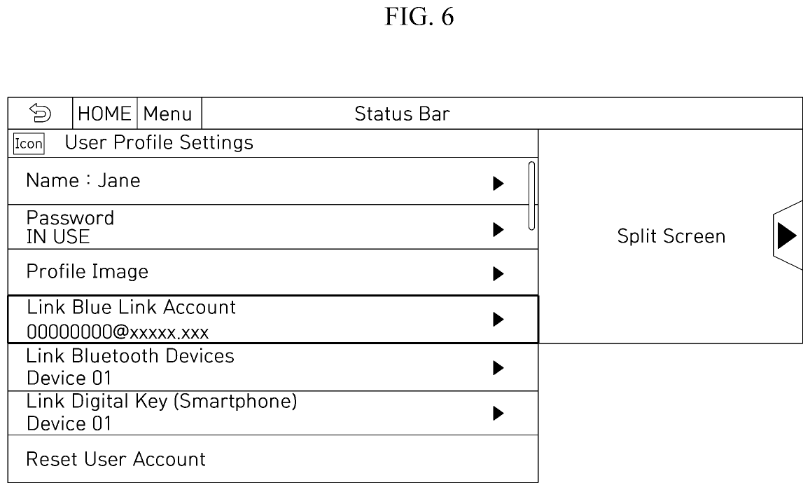

Then, when a user terminal is selected by the user (S630), information about the selected user terminal is stored as a user profile to be registered (S640). In this case, referring to FIG. 6, the information stored in the user profile preferably includes information about the user terminal which has gained access and information about accessible wireless communication information.

Here, a password may be substituted with biometric information (i.e., information indicating an authentication result of the user authentication device) such as an iris or fingerprint, or may be substituted with a password input by the user, or a password may not be used.

Meanwhile, at a time of connection with a user terminal according to an embodiment of the present invention, the controller 500 determines whether a driver is recognized through a biometric recognition device (S710), and when a result of the determination is that the driver is recognized (YES in operation S710), loads profile information of the driver (S720) and outputs the profile information of the driver through the screen input/output device 100 (S730), and attempts a connection through a first communication module or a second communication module according to a stored connection priority (1. previous connection information, 2. list priority information) of user terminals (S740).

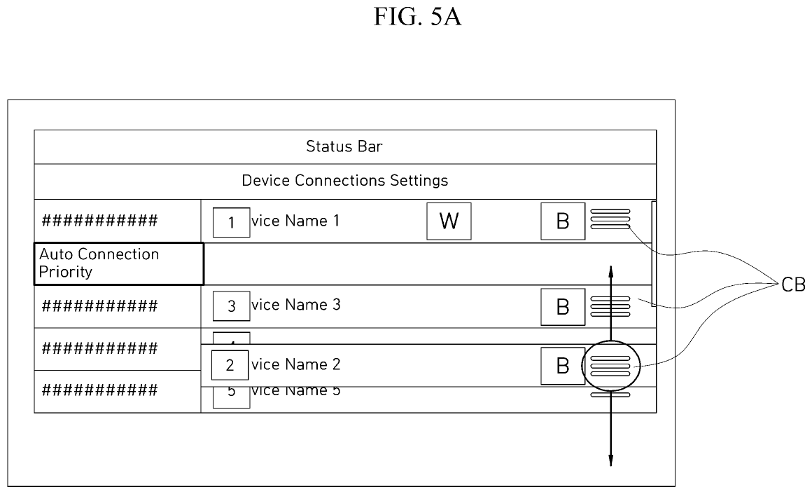

On the other hand, in the embodiment of the present invention, when the driver is not recognized through the biometric recognition device (NO in operation S710), the controller 500 loads a list of previously accessed user terminals (S750) and outputs the identified list of previously accessed user terminals to the input/output device 100 as shown in FIG. 4 (S760), and accesses the user terminal 10 according to the list of previously accessed user terminals (S770).

In addition, the controller 500 according to the embodiment of the present invention, when profile information of a driver is output (S810) and then a user selects a priority adjustment menu (not shown) (S820), may display a control bar CB for adjusting a connection priority setting of user terminals at one side of the output list of user terminals (S830), and may adjust the connection priority of a user terminal selected according to the driver selecting the CB and scrolling the CB upward or downward (S840).

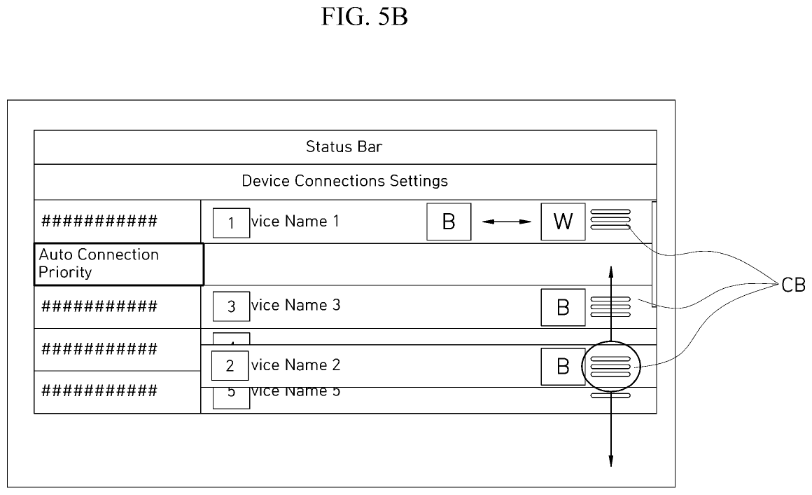

In addition, referring to FIGS. 5A and 5B, the controller 500 may display communication methods B and W capable of communicating with the user terminal 10 as icons, and by adjusting the positions of the icons, it is possible to change a priority setting for a communication device desired to access.

Meanwhile, the controller 500 may apply the priority of the communication methods to be accessed according to the type of program to be run. For example, when an audio-video-navigation (AVN) system is driven, the controller 500 may set the user terminal to be accessed through Bluetooth, which corresponds to the first communication device 200, and when a phone projection function of the user terminal is provided, the controller 500 may allow the user terminal to be accessed through WiFi communication, which corresponds to the second communication device 300, with a higher priority.

When a plurality of user terminals are detected at a time of connection with a user terminal, the controller 500 may be first completed an initial connection set-up for a user terminal, which is completed user authentication, and then perform user authentication of other connectable user terminals.

When a plurality of user terminals are connectable, the controller 500 may perform user authentication by first driving an iris or fingerprint recognition device capable of identifying the authenticator or a device for receiving identification information of a user rather than using a camera, which may not identify an authenticator, among the user authentication devices, and then may additionally use facial recognition of the user through the camera, and thus indiscriminate authentication of occupants in the vehicle can be prevented.

In addition, after a first user is authenticated and a connection with a user terminal is established through a user profile of the corresponding authenticator, a connection set-up with another user terminal may be desired. In this case, the controller may attempt a connection with a user terminal that is connectable using communication methods excluding a first connected communication method and perform the connection with the user terminal.

To this end, the program of the controller needs to be operated individually, and thus a connection with multiple user terminals may be provided through different communication methods.

The first communication device 200 and the second communication device 300 may include both a wired communication module and a wireless communication module. The wired communication module may be implemented as a power line communication device, a telephone line communication device, a cable home (MoCA) protocol, an Ethernet protocol, an IEEE1294 protocol, an integrated wired home network, or an RS-485 control device.

In addition, the wireless communication module may be implemented using a wireless local area network (WLAN), a Bluetooth protocol, a high-data-rate wireless personal area network (HDR WPAN), a ultra-wideband (UWB) protocol, a ZigBee protocol, an impulse radio protocol, a 60 GHz WPAN, a binary-code division multiple access (CDMA) protocol, wireless Universal Serial Bus (USB) technology, or wireless high-definition multimedia interface (HDMI) technology.

The memory stores a user profile, information about previously accessed user terminals, and a list of previously accessed user terminals, may store a program for connection with user terminals, and the controller 500, which is a processor, executes the program stored in the memory (not shown).

In this case, the memory refers to both a nonvolatile storage device, which keeps stored information even when power is not supplied, and a volatile storage device.

For example, the memory may include a NAND flash memory, such as a compact flash (CF) card, a secure digital (SD) card, a memory stick, a solid-state drive (SSD), and a micro SD card; a magnetic computer storage device such as a hard disk drive (HDD); and an optical disk drive, such as a compact disc read only memory (CD-ROM) and a digital versatile disc (DVD)-ROM.

The elements according to the embodiment of the present invention may be implemented in the form of software or hardware, such as a field programmable gate array (FPGA) or an application specific integrated circuit (ASIC) and may perform predetermined functions.

However, the “elements” are not limited to meaning software or hardware. Each of the elements may be configured to be stored in an addressable storage medium and configured to reproduce one or more processors.

For example, the elements may include elements such as software elements, object-oriented software elements, class elements, and task elements, processes, functions, attributes, procedures, subroutines, segments of program code, drivers, firmware, microcode, circuits, data, databases, data structures, tables, arrays, and variables.

Elements and functions provided in the corresponding elements may be combined into fewer elements or may be further divided into additional elements.

It should be understood that the blocks and the operations shown in the drawings can be performed via computer programming instructions. These computer programming instructions can be installed on processors of programmable data processing equipment, special computers, or general purpose computers. The instructions executed via the processors of data processing equipment or the computers can generate a unit that performs functions described in a block (blocks) of the flow chart. In order to implement functions in a particular manner, the computer programming instructions can also be stored in a computer available memory or computer readable memory that can support computers or programmable data processing equipment. Therefore, the instructions stored in the computer available memory or computer readable memory can produce an article of manufacture containing instruction unit that perform the functions described in the blocks of the flowchart therein). In addition, since the computer programming instructions can also be installed on computers or programmable data processing equipment, the computer programming instructions can create processes that are executed by a computer through a series of operations that are performed on a computer or other programmable data processing equipment so that the instructions performing the computer or other programmable data processing equipment can provide operations for executing the functions described in a block (blocks) of the flowchart.

In addition, the blocks of the flow chart refer to a part of code, segments or modules that include one or more executable instructions to perform one or more logical functions. It should be noted that the functions described in the blocks of the flow chart may be performed in a different order from the embodiments described above. For example, the functions described in two adjacent blocks may be performed at the same time or in reverse order in some cases.

In the embodiments, the term “˜unit,” refers to a software element or a hardware element such as a FPGA, an ASIC, etc., and performs a corresponding function. It should, however, be understood that the term “˜unit” is not limited to a software or hardware element. The “˜unit” may be implemented in addressable storage media. The “˜unit” may also be configured to reproduce one or more processors. For example, the “˜unit” may include various types of elements (e.g., software elements, object-oriented software elements, class elements, task elements, etc.), segments (e.g., processes, functions, achieves, attributes, procedures, sub-routines, program code, etc.), drivers, firmware, micro-code, circuits, data, databases, data structures, tables, arrays, variables, etc. Functions provided by elements and “˜units” may be formed by combining into a smaller number of elements and “˜units” or may be divided into additional elements and “˜units.” In addition, elements and “˜units” may also be implemented to reproduce one or more CPUs in devices or security multi-cards.

As is apparent from the above, the present invention can facilitate a connection with a user terminal having a high priority among user terminals authenticated through a user authentication device.

In addition, the present invention can allow a user to be authenticated through various types of user authentication devices or improve security through multiple authentication.

Each step included in the learning method described above may be implemented as a software module, a hardware module, or a combination thereof, which is executed by a computing device.

Also, an element for performing each step may be respectively implemented as first to two operational logics of a processor.

The software module may be provided in RAM, flash memory, ROM, erasable programmable read only memory (EPROM), electrical erasable programmable read only memory (EEPROM), a register, a hard disk, an attachable/detachable disk, or a storage medium (i.e., a memory and/or a storage) such as CD-ROM.

An exemplary storage medium may be coupled to the processor, and the processor may read out information from the storage medium and may write information in the storage medium. In other embodiments, the storage medium may be provided as one body with the processor.

The processor and the storage medium may be provided in application specific integrated circuit (ASIC). The ASIC may be provided in a user terminal. In other embodiments, the processor and the storage medium may be provided as individual components in a user terminal.

Exemplary methods according to embodiments may be expressed as a series of operation for clarity of description, but such a step does not limit a sequence in which operations are performed. Depending on the case, steps may be performed simultaneously or in different sequences.

In order to implement a method according to embodiments, a disclosed step may additionally include another step, include steps other than some steps, or include another additional step other than some steps.

Various embodiments of the present disclosure do not list all available combinations but are for describing a representative aspect of the present disclosure, and descriptions of various embodiments may be applied independently or may be applied through a combination of two or more.

Moreover, various embodiments of the present disclosure may be implemented with hardware, firmware, software, or a combination thereof. In a case where various embodiments of the present disclosure are implemented with hardware, various embodiments of the present disclosure may be implemented with one or more application specific integrated circuits (ASICs), digital signal processors (DSPs), digital signal processing devices (DSPDs), programmable logic devices (PLDs), field programmable gate arrays (FPGAs), general processors, controllers, microcontrollers, or microprocessors.

The scope of the present disclosure may include software or machine-executable instructions (for example, an operation system (OS), applications, firmware, programs, etc.), which enable operations of a method according to various embodiments to be executed in a device or a computer, and a non-transitory computer-readable medium capable of being executed in a device or a computer each storing the software or the instructions.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

Although the present invention has been described in detail above with reference to the exemplary embodiments, those of ordinary skill in the technical field to which the present invention pertains should be able to understand that various modifications and alterations may be made without departing from the technical spirit or essential features of the present invention. The scope of the present invention is not defined by the above embodiments but by the appended claims of the present invention.

What is claimed is:

1. A system for communicating with a user terminal having a plurality of heterogeneous communication modules, the system comprising:
a screen input/output device comprising a touch screen;
a first communication device configured to communicate with a user terminal via a first wireless network of a first wireless communication type;
a second communication device configured to communicate with the user terminal via a second wireless network of a second wireless communication type different from the first wireless communication type;
a user authentication device configured to receive authentication information of a user; and
a controller configured to, at a time of connection with the user terminal, authenticate a driver based on the received authentication information, load a profile of the authenticated driver to check whether the user terminal has a high priority or not, and connect to the user terminal using the first or second communication device depending on whether the user terminal has the high priority or not.

2. The system of claim 1, wherein the user authentication device comprises, or is in communication with, one or more of:
a biometric information recognizer configured to acquire biometric information of the user;
a camera configured to capture facial information of the user;
an identifier information inputter configured to output, through the screen input/output device, a graphic user interface (GUI) for receiving identifier information from the user; and
a profile selector configured to output a list of registered profiles and receive the user's selection of one of the registered profiles.

3. The system of claim 2, wherein the controller is further configured to identify the user based on at least one of the acquired biometric information of the user, the captured facial information of the user, the received identifier information, and the registered profile selected by the user.

4. The system of claim 1, wherein the controller is further configured to:
search for the user terminal accessible through the first communication device and the second communication device;
display, on the touch screen of the screen input/output device, information about the user terminal;
receive a user input selecting the user terminal from the information displayed on the touch screen; and
in response to receiving the user input, store, in a data storage, information about the selected user terminal as a profile of the user.

5. The system of claim 1, wherein the controller is further configured to:
recognize, using the user authentication device, the driver;
upon the driver being recognized, retrieve profile information of the driver and output, via the screen input/output device, the retrieved profile information; and
attempt to access, using the first or second communication device, the user terminal according to a connection priority of the user terminal included in the retrieved profile information.

6. The system of claim 1, wherein the controller is further configured to, when profile information of the driver is output and then the user selects a priority adjustment menu setting, display a control bar configured to allow the user to adjust a connection priority of the user terminal at one side of an output list of the user terminals, and to adjust the connection priority of the user terminal selected according to the driver selecting the control bar and then scrolling the control bar upward or downward.

7. The system of claim 1, wherein the controller is further configured to:
display a communication unit configured to perform communication with the user terminal as an icon; and
adjust a position of the icon to change a priority setting for the communication unit that the user wishes to access.

8. The system of claim 1, wherein the controller is further configured to, in response to a failure to recognize the driver based on a function of a biometric information recognizer, check a list of previously accessed user terminals, and attempt to access the user terminal according to the list of the previously accessed user terminals.

9. The system of claim 1, wherein the controller is configured to apply a priority for the first or second communication device depending on a type of a program to be run.

10. A method of operating a system for communicating with a user terminal having a plurality of heterogeneous communication modules, the method comprising:
detecting a user terminal and then registering user profile information including user authentication information;
after registering the user profile information, receiving the user authentication information to perform authentication on a user;
in response to the user being authenticated, loading the user profile information corresponding to the authenticated user; and
performing, based on the user profile information, connection with the user terminal having a high connection priority.

11. The method of claim 10, further comprising, in response to the user not being authenticated, performing, based on a list of the user terminals previously accessed, connection with a user terminal having the high connection priority.

12. The method of claim 10, further comprising;
when a request signal for changing a connection priority of the user terminal is input after the loading of the profile information, outputting a control bar configured to allow the user to change a connection priority at one side of a list of the user terminals; and
adjusting the connection priority according to a position of the control bar changed by the user.
